(19) United States
(12) Patent Application Publication
(10) Pub. No.: US 2025/0376779 A1
(43) Pub. Date: Dec. 11, 2025

(54) MULTI-ANODE ELECTROLYTIC CELL

(71) Applicant: China Aluminum International Engineering Corporation Limited, Beijing (CN)

(72) Inventors: Wei LIU, Shenyang (CN); Pengfei DU, Shenyang (CN); Song FU, Shenyang (CN); Xi CAO, Shenyang (CN); Hongwu HU, Shenyang (CN); Yafeng LIU, Shenyang (CN)

(21) Appl. No.: 18/573,073

(22) PCT Filed: Nov. 30, 2023
(86) PCT No.: PCT/CN2023/135408

§ 371 Date: Dec. 21, 2023

(30) Foreign Application Priority Data
Feb. 3, 2023 (CN) 202310054827.X

(51) Int. Cl. C25C 7/02; C25C 3/02; C25C 7/00; C25C 7/04

(52) U.S. Cl. CPC C25C 7/025; C25C 3/02; C25C 7/005; C25C 7/04

(57) ABSTRACT

A multi-anode electrolytic cell relating to molten salt lithium electrolysis. The cell includes a sealed container with at least two electrode groups uniformly arranged inside. Each group has an anode and a cathode, and the top end of the anode penetrates the top end of the sealed container to protrude out of the sealed container. A separation mesh is arranged on the outer side of the anode. The cathode is arranged on the outer side of the separation mesh and connected with a conducting plate. The top end of the conducting plate protrudes out of the top end of the sealed container. A bottom-removed collecting hood is arranged above the cathode such that it surrounds the outer side of the anode. The physical fields in the sealed container are uniformly distributed by uniformly arranging the electrode groups, thereby ensuring a continuous and stable electrolysis process.

### TECHNICAL FIELD

The present invention belongs to the technical field of molten salt lithium electrolysis, and particularly relates to a multi-anode electrolytic cell.

### BACKGROUND

At present, in the industry, the mechanism of preparing nonferrous metal by applying an electrolytic method is more and more advanced, and a small-capacity electrolytic cell cannot meet the requirements of large capacity, simple operation and safety and environmental protection in the industry, and large-capacity, energy-saving and environment-friendly electrolytic equipments inevitably come to have broad prospects along with the enhancement of international environmental protection consciousness and the publication and implementation of a domestic “double-carbon” strategic target.

Patent application CN104562092B discloses a multi-anode metal lithium electrolytic cell, wherein the cathode busbar is arranged on one side of the electrolytic cell, and after current flows to the cathode from the anode through electrolyte, most of the current flows out from the cathode of the side on which the cathode busbar is arranged, and the current distribution on the cathode varies widely, and certain difference exists in electric field distribution in the electrolytic cell, thereby causing deviations for the distributions of temperature field and flow field, and thus the stable proceeding of the electrolytic process is further influenced.

Patent application CN211284567U discloses a metal lithium electrolytic cell, the structure of which is in the form of a multi-anode electrolytic cell. Considering that in order to reduce chlorine leakage in the actual production process, a protective hood is arranged above the cover of the electrolytic cell, but the protective hood also encloses the cathode and anode, so that the protective hood has to be opened during replacement of the anode, so as to meet the space requirement of electrode replacement. During this operation, the chlorine is inevitably dispersed out of the electrolytic cell, thereby affecting the chlorine collection effect.

In view of the problems in the structure for the multi-anode electrolytic cells as mentioned above, and considering the requirements of the industry on operability, environmental protection and large capacity of the electrolytic cell, one or more of the urgent problems for those skilled in the art is how to improve the structure, assembly mode and operation method of the equipment on the basis of the prior art, to enable the electrolytic cell to have the capacity of large-scale production, further reduce the discharge amount of production wastes and reduce the workload of daily production and maintenance.

### SUMMARY

In view of the above disadvantages, the present invention provides a multi-anode electrolytic cell which can increase the yield, reduce the amount of waste discharge, and effectively collect the product, and prevent the product from being contaminated.

The multi-anode electrolytic cell according to the present application comprises a sealed container, wherein at least two electrode groups are uniformly arranged in the sealed container, and each electrode group consists of an anode and a cathode, and the top end of the anode penetrates through the top end of the sealed container to protrude out of the sealed container. A separation mesh is arranged on the outer side of the bottom of the anode, and the cathode is arranged on the outer side of the separation mesh and is connected with a current-conducting plate. The top end of the current-conducting plate protrudes out of the top end of the sealed container, and a bottom-removed collecting hood is arranged above the cathode, and the collecting hood is arranged such that it surrounds the outer side of the anode, for collecting metal generated by ionization of the cathode.

In one embodiment, the at least two electrode groups are arranged side by side in a positive integer row(s), and the deviation value of the current intensity among the electrode groups is less than or equal to 1%.

In one embodiment at least electrode groups are arranged side by side in a single row or in two rows, and the deviation value of the current intensity among the electrode groups is less than or equal to 1%.

In one embodiment, the top of the collecting hood is inclined at an angle of 5° to 30°.

In one embodiment, the top of the collecting hood is in communication with the collecting barrel, so that the product in collecting hood moves along the inner wall of the top of collecting hood to the collecting barrel, thereby the product is automatically collected.

In one embodiment, the sealed container is further provided with a feeding pipe and a flue pipe, and the pressure in the flue pipe is negative pressure.

In one embodiment, the sealed container comprises a top cover, a cell shell and a base in sequence, and a top flange is arranged on the top of the cell shell, and an insulator is arranged between the edge of the top cover and the top flange, and a bottom flange is arranged at the bottom of the cell shell, and an insulator is arranged between the bottom flange and the base.

In one embodiment, the top of the sealed container is connected to an upper frame, and the top of the anode is sequentially connected with a steel bar, an explosion welding block and an aluminum guide rod, and an anode bus and an insulator are sequentially arranged between the aluminum guide rod and the upper frame.

In one embodiment, the anode is connected with the steel bar via a phosphorus pig iron.

In one embodiment, a cathode bus support is arranged on the top end surface of the sealed container, and an insulator and a cathode bus are sequentially arranged between the cathode bus support and the conducting plate.

In one embodiment, an anode insulating sleeve is arranged between the anode and the sealed container, and a conducting plate insulating sleeve is arranged between the conducting plate and the sealed container.

In one embodiment, the normal insulation resistances of the anode insulating sleeve and the conducting plate insulating sleeve are greater than or equal to 1.0×10¹³Ω; the insulation resistances of the anode insulating sleeve and the insulating sleeve of the conducting plate after soaking are greater than or equal to 1.0×10¹²Ω.

Beneficial effects achieved:
the present invention ensures that the physical fields in the sealed container are uniformly distributed by uniformly arranging the electrode groups, thereby ensuring a continuous and stable electrolysis process. By setting up at least two electrode groups, the production boosts. Furthermore, by providing the collecting hood and collecting barrel, the product produced by the cathode can be directly collected, and the product does not need to be separated individually, and thus the product is prevented from being contaminated. Furthermore, by providing the flue pipe, the negative pressure in the flue pipe can separate and collect the gas which is produced in the sealed container, ensuring that the process is environment-friendly.

### BRIEF DESCRIPTION OF DRAWINGS

In order to more clearly illustrate the embodiments of the present invention or the technical solutions in the prior art, the drawings needed and used in the description of the embodiments or the prior art will be briefly described below, and it is obvious that the drawings in the following description are only some embodiments of the present invention, and other drawings can be obtained by those skilled in the art without creative efforts.

In the drawings:

FIG. 1 is a cross-sectional view in a vertical direction of a multi-anode electrolytic cell having a single row of electrode groups in accordance with the present invention.

FIG. 2 is a partially enlarged view of a portion B in FIG. 1.

FIG. 3 is a partially enlarged view of a portion C in FIG. 1.

FIG. 4 is a top view of a multi-anode electrolytic cell having a single row of electrode groups in accordance with the present invention.

FIG. 5 is a cross-sectional view taken along line A-A in FIG. 4.

FIG. 6 is a partially enlarged view of a portion D in FIG. 5.

FIG. 7 is a partially enlarged view of a portion E in FIG. 5.

FIG. 8 is a partially enlarged view of a portion F in FIG. 5.

FIG. 9 is a cross-sectional view in a vertical direction of a multi-anode electrolytic cell having double rows of electrode groups in accordance with the present invention.

FIG. 10 is a top view of a multi-anode electrolytic cell having double rows of electrode groups in accordance with the present invention.

FIG. 11 is a cross-sectional view taken along line A-A in FIG. 10.

In the drawings: 1, cell shell; 2, top cover; 3, base; 4, rib plate; 5, bolt; 6, washer; 7, nut; 8, insulating sleeve; 9, insulating washer; 10, insulator; 11, upper frame; 12, anode; 13, steel rod; 14, explosive welding block; 15, aluminum guide rod; 16, phosphorus pig iron; 17, spiral clamp; 18, hook; 19, stud; 20, nut; 21, washer; 22, insulating sleeve; 23, insulating washer; 24, anode bus; 25, insulator; 26, anode insulating sleeve; 27, cathode; 28, conducting plate; 29, cathode bus; 30, cathode bus support; 31, insulator; 32, stud; 33, nut; 34, washer; 35, insulating washer; 36, conducting plate insulating sleeve; 37, separation mesh; 38, collecting hood; 39, hanging plate; 40, bolt; 41, nut; 42, washer; 43, insulating sleeve; 44, insulating washer; 45, rib plate; 46, collecting barrel; 47, feeding pipe; 48, flue pipe.

### DETAILED DESCRIPTION

The technical solutions in the embodiments of the present invention will be clearly and completely described below with reference to the embodiments of the present invention. Apparently, the described embodiments show only a part of the embodiments of the present invention, not all of the embodiments. All other embodiments, which can be obtained by a person skilled in the art without creative efforts based on the embodiments of the present invention, are within the scope of protection of the present invention.

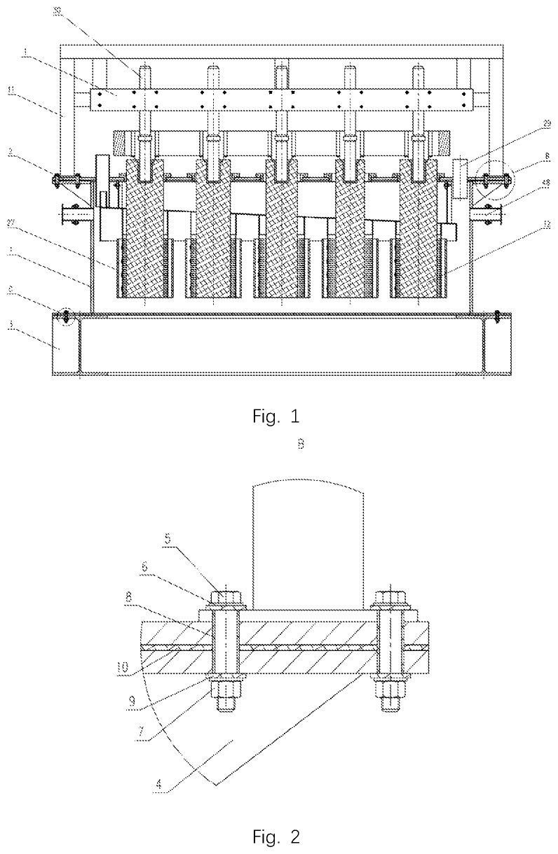

Referring to FIGS. 1 to 11, the present invention seeks protection for a multi-anode electrolytic cell including a sealed container, at least two electrode groups are uniformly arranged in the sealed container, and the number of the electrode groups is a positive integer greater than or equal to 2. Each electrode group is composed of an anode 12 and a cathode 27. The top end of the anode 12 passes through the top end of the sealed container and protrudes out of the sealed container. A separation mesh 37 is arranged outside the bottom of the anode 12. The cathode 27 is arranged outside of the separation mesh 37. The cathode 27 is connected with a conducting plate 28. The top end of the conducting plate 28 protrudes out of the top end of the sealed container. A collecting hood 38 in which a bottom is removed (herein after, bottom-removed collecting hood) is arranged above the cathode 27. The collecting hood 38 is arranged such that it surrounds the outside of the anode 12, for collecting metal generated by electrolysis of the cathode 27. The current intensity is increased by 5-10 kA each time one electrode group is further added.

Taking fused salt electrolytic lithium as an example, lithium produced by electrolytic reduction of the cathode 27 floats upwards in the electrolyte and into the bottom-removed collecting hood 38, and is collected at the inner wall of the top of the collecting hood 38, and continuously floats upwards into the collecting barrel 46 arranged above, so that the collection of the product on the whole is completed. Intentional manual collection is not needed in the whole process, and the collected lithium is not contaminated by the outside.

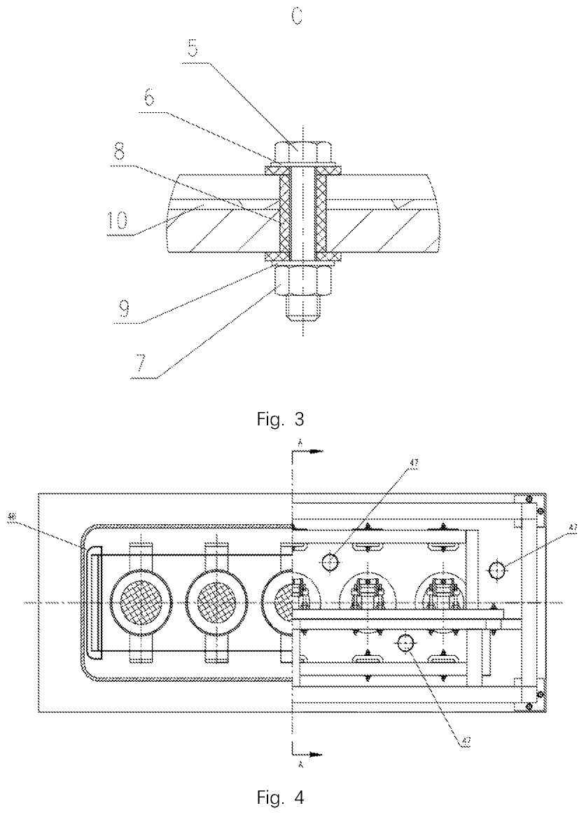

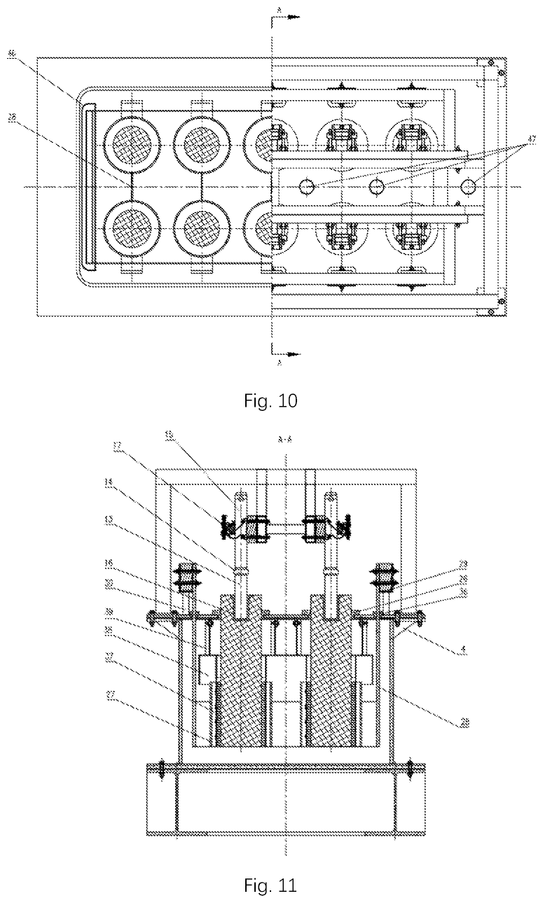

In one embodiment, at least two electrode groups may be arranged in a positive integer number of rows, such as a single row, a double or two rows, three rows, four rows, and the like. Preferably, the electrode groups are arranged side by side in a single row or in two rows. With reference to FIGS. 1 and 4, the electrode groups are arranged in a single row, and with reference to FIGS. 9 and 10, the electrode groups are arranged in two rows. The deviation value of the current intensity among different electrode groups is less than or equal to 1%.

Referring to FIGS. 1 and 9, in one embodiment, the top of collection hood 38 is inclined at an angle of 5° to 30°. When the top of collecting hood 38 is inclined, the top of collecting hood 38 (in particular, the highest point of the top) is in communication with the collecting barrel 46, so that the product in the collecting hood 38 can move along the inner wall of the top of collecting hood 38 to the collecting barrel 46, thereby the product can be automatically collected.

Referring to FIGS. 1, 4, 9 and 10, in one embodiment, a feeding pipe 47 and a flue pipe 48 are also arranged on the sealed container, and the pressure in the flue pipe 48 is a negative pressure.

Referring to FIGS. 1, 5, 9 and 11, in one embodiment, the top of the sealed container is connected to an upper frame 11; the anode 12 is a graphite anode, and the top of the anode 12 is sequentially connected with a steel bar 13, an explosive welding block 14 and an aluminum guide rod 15. In one embodiment, the anode 12 is connected with the steel bar 13 via a phosphorus pig iron 16. An anode bus 24 and an insulator 25 are sequentially arranged between the aluminum guide rod 15 and the upper frame 11.

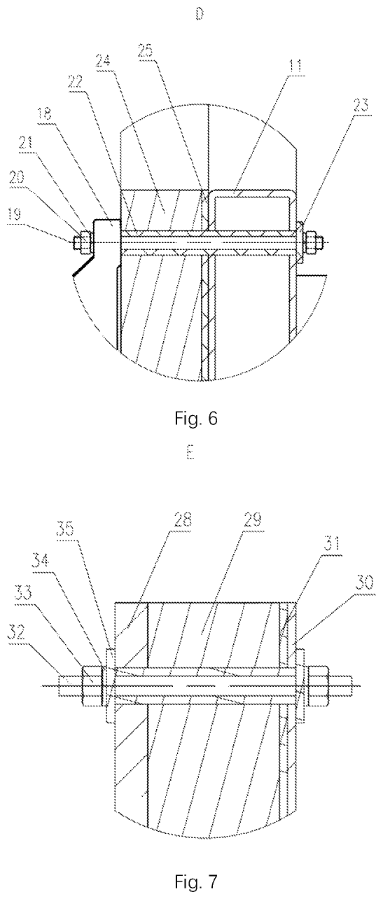

Referring to FIG. 7, in one embodiment, a cathode bus support 30 is arranged on the top end surface of the sealed container. An insulator 31 and a cathode bus 29 are sequentially arranged between the cathode bus support 30 and the conducting plate 28.

In one embodiment, an anode insulating sleeve 26 is arranged between the anode 12 and the sealed container, and a conducting plate insulating sleeve 36 is arranged between the conducting plate 28 and the sealed container.

In one embodiment, the normal insulation resistances of the anode insulating sleeve 26 and the conducting plate insulating sleeve 36 are greater than or equal to 1.0×10¹³Ω; the insulation resistances of the anode insulating sleeve 26 and the conducting plate insulating sleeve 36 after soaking are greater than or equal to 1.0×10¹²Ω.

In one embodiment, the sealed container comprises a top cover 2, a cell shell 1 and a base 3 in sequence. A rib plate 4 is arranged between the top cover 2 and the cell shell 1 for increasing stability. The top cover 2 and the cell shell 1, and the cell shell 1 and the base 3 are fixed through a first assembly. Referring to FIGS. 2 and 3, wherein in FIG. 2, the top cover 2 is fixed with the cell shell 1 through the first assembly, and a top flange is arranged on the top of the cell shell 1. An insulator 10 is arranged between the edge of the top cover 2 and the top flange. A bolt 5 sequentially passes through the top cover 2, the insulator 10 and the top flange to be connected with a nut 7. A washer 6 and an insulating washer 9 are arranged between the bolt 5 and the top cover 2 and between the nut 7 and the top flange. The outer side of the bolt 5 is sleeved with an insulating sleeve 8. FIG. 3 shows that, a bottom flange is provided at the bottom of the cell shell, and the bottom flange is fixed with the base 3 via the first assembly, wherein an insulator 10 is arranged between the bottom flange and the base 3, and a bolt 5 sequentially passes through the bottom plate of the cell shell, the insulator 10 and the base 3 to be connected with the nut 7.

Referring to FIG. 6, in one embodiment, the anode bus 24 and the upper frame 11 are connected by clamping via a spiral clamp 17. The spiral clamp 17 comprises a hook 18 and a stud 19. The hook 18 is fixed on the anode bus 24 and the upper frame 11 by means of bolt fastening. The stud 19 passes through the hook 18, the anode bus 24 and the upper frame 11. Nuts 20, washers 21 and insulating washers 23 are arranged at both ends of the stud 19, and an insulating sleeve 22 is sleeved on the side surface of the stud 19.

Referring to FIG. 7, in one embodiment, the conducting plate 28 and the cathode bus support 30 are connected by a stud 32. One end of the stud 32 sequentially passes through the conducting plate 28, the cathode bus 29, the insulator 31 and the cathode bus support 30. Each end of the stud 32 is connected with a nut 33. A washer 34 and an insulating washer 35 are arranged between the nut 33 and the conducting plate 28 and between the nut 33 and the cathode bus support 30.

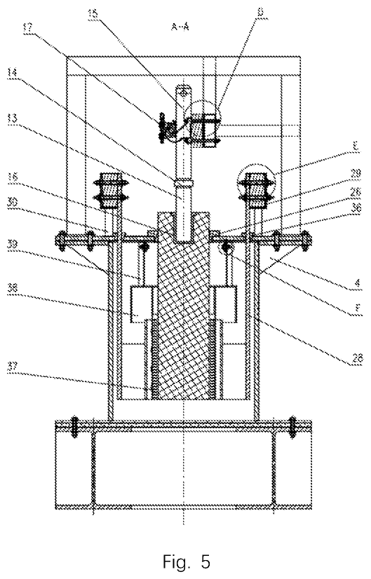

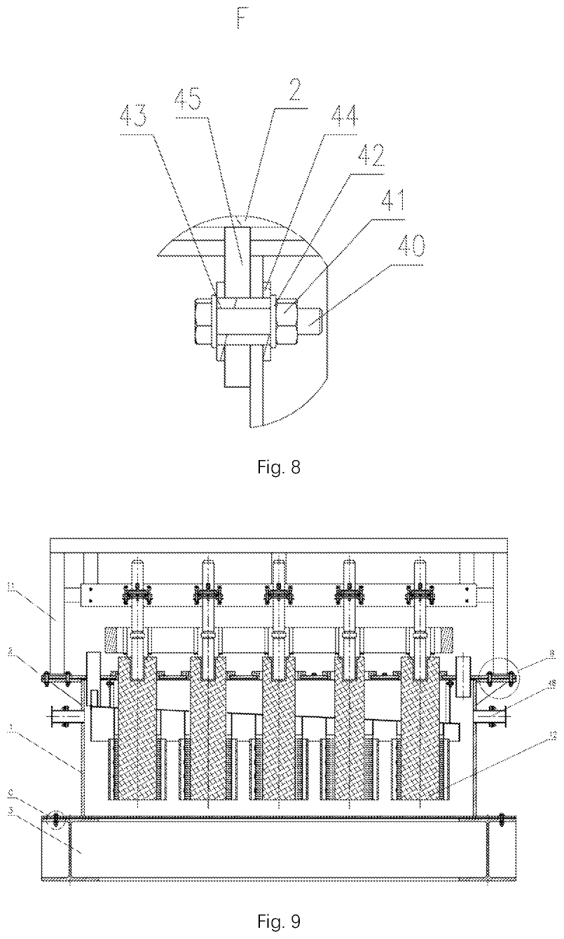

Referring to FIGS. 5 and 8, in one embodiment, the top of the collection hood 38 is connected to the inner wall of the top cover 2 by means of a hanging plate 39. Preferably, a rib plate 45 is arranged on the inner wall of the top cover 2. A bolt 40 passes through the rib plate 45 and the hanging plate 39 to be connected with a nut 41. A washer 42 and an insulating washer 44 are arranged between the nut 41 and the hanging plate 39 and between the bolt 40 and the rib plate 45, and an insulating sleeve 43 is sleeved on the outer side of the bolt 40.

The following are preferred embodiments.

### First Embodiment

The hook 18 is arranged on the anode bus 24 in the single-row anode lithium electrolytic cell. Engagement between the spiral clamp 17 and the hook 18 presses the anode 12 perpendicularly on the anode bus 24. The cathode 27 is concentrically arranged around the anode 12. The cathode 27 is in an annular form, and the conducting plate 28 is welded on the outer wall of the cathode 27. The conducting plate 28 extends outwardly over the top cover 2, and is insulated from the top cover 2 in a bolt fastening manner. The metal lithium produced in the electrolysis process continuously moves upwards under the action of buoyancy and is collected in the collecting hood 38, and is further collected into the collecting barrel 46 positioned above the collecting hood 38 along with the increase of the yield, so that the lithium can be fed out collectively at a later stage. The hanging plate 39 is welded on the collecting hood 38 and is in insulated connection with the rib plate 45 under the top cover 2. Meanwhile, the feeding pipes 47 are arranged on the top cover 2 for adding raw materials. The side wall of the cell shell 1 is provided with a flue pipe 48 for collecting waste gas. Collection of the waste gas is realized by at negative pressure principle. In order to meet the strength requirement of the top cover 2 for bearing weight, rib plates 4 are welded on the periphery of the lower side of the top cover 2, and the other sides of the rib plates 4 are welded on the outer side wall plate of the cell shell 1. Finally, the whole electrolytic cell is fixed on the base 3 in an insulated manner. The base 3 which has a high strength and high stability can ensure that the whole electrolytic cell is stably installed on the ground. In addition, the number of the anodes 12 in the single-row anode electrolytic cell is 5, and the number of the feeding pipes 47 is 6.

### Second Embodiment

The double-row anode electrolytic cell has the same structure and component types as the single-row anode electrolytic cell, and anodes 12 are arranged in double rows, each row of anodes 12 are respectively fixed on an anode bus 24, and the total number of the anodes 12 is 10. The number of the feeding pipes 47 is 6.

While the present invention has been described in connection with what is presently considered to be the most practical and preferred embodiments, it is to be understood that the present invention is not to be limited to the disclosed embodiments, but on the contrary, is intended to cover various modifications and equivalent arrangements included within the spirit and scope of the appended claims.

1. A multi-anode electrolytic cell, characterized in that it comprises a sealed container, wherein at least two electrode groups are uniformly arranged in the sealed container, and each electrode group consists of an anode and a cathode, and the top end of the anode penetrates through the top end of the sealed container to protrude out of the sealed container, a separation mesh is arranged outside the bottom of the anode, the cathode is arranged outside the separation mesh, the cathode is connected with a conducting plate, the top end of the conducting plate protrudes out of the top end of the sealed container, a bottom-removed collecting hood is arranged above the cathode, and the collecting hood is arranged such that it surrounds the outside of the anode, for collecting metal generated by ionization of the cathode.

2. The multi-anode electrolytic cell according to claim 1, wherein the at least two electrode groups are arranged side by side in a positive integer row(s), and the deviation value of the current intensity among the electrode groups is less than or equal to 1%.

3. The multi-anode electrolytic cell according to claim 1, wherein at least electrode groups are arranged side by side in a single row or in two rows, and the deviation value of the current intensity among the electrode groups is less than or equal to 1%.

4. Multi-anode electrolytic cell according to claim 1, wherein the top of the collecting hood is inclined at an angle of 5° to 30°.

5. Multi-anode electrolytic cell according to claim 4, wherein the top of the collecting hood is in communication with the collecting barrel, so that the product in collecting hood moves along the inner wall of the top of collecting hood to the collecting barrel, thereby the product is automatically collected.

6. Multi-anode electrolytic cell according to claim 1, wherein the sealed container is further provided with a feeding pipe and a flue pipe, and the pressure in the flue pipe is a negative pressure.

7. Multi-anode electrolytic cell according to claim 1, wherein the sealed container comprises a top cover, a cell shell and a base in sequence, and a top flange is arranged on the top of the cell shell, and an insulator is arranged between the edge of the top cover and the top flange, and a bottom flange is arranged at the bottom of the cell shell, and an insulator is arranged between the bottom flange and the base.

8. The multi-anode electrolytic cell according to claim 1, wherein the top of the sealed container is connected to an upper frame, and the top of the anode is sequentially connected with a steel bar, an explosion welding block and an aluminum guide rod, and an anode bus and an insulator are sequentially arranged between the aluminum guide rod and the upper frame.

9. The multi-anode electrolytic cell according to claim 8, wherein the anode is connected with the steel bar via a phosphorus pig iron.

10. The multi-anode electrolytic cell according to claim 8, wherein a cathode bus support is arranged on the top end surface of the sealed container, and an insulator and a cathode bus are sequentially arranged between the cathode bus support and the conducting plate.

11. A multi-anode electrolytic cell according to claim 1, wherein an anode insulating sleeve is arranged between the anode and the sealed container, and a conducting plate insulating sleeve is arranged between the conducting plate and the sealed container.

12. The multi-anode electrolytic cell according to claim 11, wherein the normal insulation resistances of the anode insulating sleeve and the conducting plate insulating sleeve are greater than or equal to 1.0×10¹³Ω; the insulation resistances of the anode insulating sleeve and the insulating sleeve of the conducting plate after soaking are greater than or equal to 1.0×10¹²Ω.
